(19) United States
(12) Patent Application Publication
(10) Pub. No.: US 2026/0005260 A1
(43) Pub. Date: Jan. 1, 2026

(54) LOW ENTHALPY ALLOY CATALYSTS AND METHODS

(71) Applicant: The Trustees of Indiana University, Bloomington, IN (US)

(72) Inventors: Jian Xie, Zionsville, IN (US); Hannah Zhang, Indianapolis, IN (US); Guangqi Zhu, Indianapolis, IN (US)

(21) Appl. No.: 19/254,386

(22) Filed: Jun. 30, 2025

Related U.S. Application Data
(60) Provisional application No. 63/665,585, filed on Jun. 28, 2024.

(51) Int. Cl. H01M 4/92

(52) U.S. Cl. CPC H01M 4/926

(57) ABSTRACT

Low enthalpy alloy catalysts and methods. The low enthalpy catalyst includes a low enthalpy alloy core and a Pt-rich shell covering the low enthalpy alloy core. The low enthalpy alloy core may include a platinum group metal, a rare earth metal, and/or a transition metal. The low enthalpy catalyst may be in particulate form, preferably having average particulate sizes in the range of a few nanometers. Methods of making the low enthalpy alloy catalysts include embedding metal ions in a carbon-nitrogen network on a carbon support, annealing the carbon support with the embedded ions, and acid leaching the annealed carbon support with the embedded ions to form a low enthalpy alloy catalyst having a low enthalpy alloy core encapsulated within a Pt-rich shell. The metal ions may all be embedded at the same time, or some metal precursors could be added and embedded during the annealing.

### CROSS-REFERENCE TO RELATED APPLICATIONS

This application claims the benefit of provisional U.S. Patent Application No. 63/665,585 filed Jun. 28, 2024, the contents of which are incorporated herein by reference.

### BACKGROUND OF THE INVENTION

The invention generally relates to chemical catalysts, and more particularly to low enthalpy alloy catalysts and methods of manufacturing low enthalpy catalysts.

With the surge of interest in electrification of transportation driven by global climate change, the need for powertrains using non-carbon energy sources has become more urgent than ever. Fuel cell electric vehicles (FCEVs) that use a polymer electrolyte membrane fuel cell (PEMFC) have advantages over internal combustion engines and other renewable energy vehicles, as examples, high efficiency, zero emission, fast fueling, unique power and energy scalability (without heavy penalty from increased mass).

Polymer electrolyte membrane fuel cells utilize membrane electrode assemblies (MEAs) that traditionally comprise a proton (or polymer) exchange membrane (PEM) between a pair of catalyst layers (CLs), each of which is applied to or otherwise contacted by a gas diffusion layer (GDL) that functions as an electrode (anode or cathode). Examples of electrodes currently used in MEAs include a catalyst layer comprising a porous support, catalyst nanoparticles applied to the support (such a support is commonly referred to as a catalyst support), and an electrolyte film overlying the catalyst nanoparticles to form an electrolyte/catalyst interface where the oxygen reduction reaction (ORR) occurs. A portion of such a membrane electrode assembly 10 is schematically represented in FIG. 5, in which a catalyst layer 12 comprising a catalyst 14 dispersed on a support 16 is disposed between a proton exchange membrane 18 and electrode 20. A portion of a catalyst support of such a catalyst layer is schematically represented in FIG. 6. As also represented in FIG. 6, catalyst supports, catalyst nanoparticles, and electrolytes used in membrane electrode assemblies have included, respectively, carbon-containing particles, platinum group metal (PGM) nanoparticles (NPs), and ionomers.

In addition to fuel cells, platinum group metal nanoparticle catalysts have been widely used in many fields, such as but not limited to electrolyzers (such as used in hydrogen production from water electrolysis), petroleum refining, environmental (gas remediation), industrial chemical production (e.g., ammonia production, fine chemicals), electronics, and medical fields. Additionally, platinum group metal nanoparticle catalysts have been widely used in a variety of other industrial processes to perform various reactions, such as the aforementioned oxygen reduction reaction, as well as oxygen evolution reactions, hydrogen evolution reaction (HER), CO₂/CO reduction and many reactions of refining petroleum. However, platinum group metal nanoparticle catalysts experience significant performance loss during long-term operations, which is rooted in catalyst stability, a long-standing challenge. The performance loss is caused by catalyst degradation as catalyst particles become larger after long term operation. The modified Ostwald ripening represented in FIG. 7 is one of the major mechanisms responsible for catalyst degradation of platinum group metal nanoparticles. This ripening is a process in which smaller platinum group metal nanoparticles are dissolved (oxidized) and become platinum group metal ions, then diffuse to the surfaces of larger platinum group metal nanoparticles, where the smaller platinum group metal nanoparticles are deposited (reduced) and enlarge the larger platinum group metal nanoparticles onto which they have been diffused.

It would be desirable if catalysts existed that were capable of exhibiting greater stability during long-term operations and thereby exhibiting improved useful lifespans and reduced performance losses.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, low enthalpy catalysts and methods of manufacturing low enthalpy alloy catalysts. The present invention particularly provides, but is not limited to, low enthalpy platinum group metal nanoparticle catalysts capable of use in a wide variety of industry applications, as examples, polymer electrolyte membrane for use in fuel cells and electrolyzers used in hydrogen production from water electrolysis.

According to a nonlimiting aspect of the invention, a platinum group metal (PGM) nanoparticle catalyst is formed of a binary alloy PGMₓA_{y} or a ternary or higher order PGM alloy PGMₓA_{y}B_{(1-x-y)}, wherein A is a rare earth metal and/or a transition metal and the PGM nanoparticle catalyst has a mixing enthalpy (ΔHₘᵢₓ) of less than −7.0 KJ/mol. If the binary alloy PGMₓA_{y}, the PGM nanoparticle catalyst may be, for example, PtSc, PtCe, PtV, PtY, PtZr, PtTi, Pt₃Sc, Pt₃Ce, Pt₃V, Pt₃Y, Pt₃Zr, or Pt₃Ti. If the ternary or higher order alloy PGMₓA_{y}B_{(1-x-y)}, the PGM nanoparticle catalyst may be, for example, PtScCo, PtCeCo, PtVCo, PtYCo, PtZrCo, PtTiCo, Pt₃ScCo, Pt₃CeCo, Pt₃VCo, Pt₃YCo, Pt₃ZrCo, or Pt₃TiCo.

According to another nonlimiting aspect of the invention, a method of manufacturing a low enthalpy alloy catalyst includes co-depositing at least three metal elements, including a platinum group metal, cobalt or nickel, and a rare earth metal or a transition metal, simultaneously on a Pt-seeded carbon supports with nitrogen-rich compounds. The at least three metal elements are embedded in carbon-nitrogen networks on the Pt-seeded carbon supports. The embedded metal elements on the Pt-seeded carbon supports are annealed under diluted H₂ atmosphere to form ordered intermetallic structured ternary Pt—A—B alloy, wherein A comprises the rare earth metal or the transition metal and B is cobalt or nickel. The ordered intermetallic structured ternary alloy is acid leached to remove loose attached small particles and form a low enthalpy alloy catalyst having a low enthalpy alloy core encapsulated within a Pt-rich shell.

According to another nonlimiting aspect of the invention, a method of manufacturing a low enthalpy alloy catalyst includes synthesizing Pt—A alloy particles on Pt-seeded carbon supports with nitrogen-rich compounds, wherein A is a rare earth metal or a transition metal. The synthesized Pt—A particles on the Pt-seeded carbon supports are annealed under diluted H₂ atmosphere to form an ordered intermetallic Pt—A structure. Co or Ni is thermally diffused into the ordered intermetallic Pt—A structure to form an ordered intermetallic structured ternary alloy. The ordered intermetallic structured ternary alloy is acid leached to remove loose attached small particles and form a low enthalpy alloy catalysts comprising a low enthalpy alloy core encapsulated within a Pt-rich shell.

According to yet another nonlimiting aspect, a low enthalpy catalyst is provided that is manufactured according to any of the methods described above.

According to still another nonlimiting aspect, a low enthalpy catalyst includes a low enthalpy alloy core and a Pt-rich shell covering the low enthalpy alloy core.

Technical aspects of low enthalpy catalysts and/or methods as described above preferably include the ability to reduce degradation of a particle catalyst, particularly a nanoparticle platinum group metal catalyst caused by platinum group metal oxidation (dissolution) during the Ostwald ripening process and thereby improve long-term stability of the catalyst.

These and other aspects, arrangements, features, and/or technical effects will become apparent upon detailed inspection of the figures and the following description.

### BRIEF DESCRIPTION OF THE DRAWINGS

FIG. 1 is a schematic representation for obtaining a low enthalpy alloy (LEA) catalyst in which the intrinsic stability of the low enthalpy alloy catalyst is increased by incorporating certain elements that have lower formation enthalpy to reduce the total Gibbs free energy (ΔG_{f}) of the alloy catalyst formation in accordance with certain aspects of the present invention.

FIG. 2 schematically illustrates two methods of synthesizing low enthalpy alloy catalysts according to nonlimiting aspects of the invention.

FIGS. 3A-3C relate to evaluations of a low enthalpy alloy Pt₃ScCo alloy catalyst manufactured in accordance with certain principles of the present invention. FIG. 3A is a graph of an ex situ synchrotron XRD spectrum of the low enthalpy alloy Pt₃ScCo alloy catalyst. FIG. 3B is an atomic resolution HAADF-STEM image of a single Pt₃ScCo alloy catalyst particle. FIG. 3C is an EDS elemental mapping of the Pt₃ScCo alloy catalyst particle.

FIGS. 4A-4D are graphs relating to the low enthalpy alloy Pt3ScCo alloy catalyst. FIG. 4A shows cyclic voltammetry (CV) curves of electrochemical active surface area (ECSA) before and after 30k accelerated stress test (AST) cycles. FIG. 4B shows polarization curves of a linear scan. FIG. 4C shows calculated ECSA from FIG. 4A. FIG. 4D shows calculated mass activity (MA) from FIG. 4B.

FIG. 5 schematically represents a fragmentary cross-section of a membrane electrode assembly, including a polymer exchange membrane (PEM), electrode (gas diffusion layer), and catalyst layer thereof.

FIG. 6 schematically represents a fragment of a catalyst support of a type known and used in membrane electrode assemblies.

FIG. 7 is a schematic representation of Ostwald ripening.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiments to which the drawings relate. The following detailed description also describes certain investigations relating to the embodiments, and identifies certain but not all alternatives of the embodiments. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

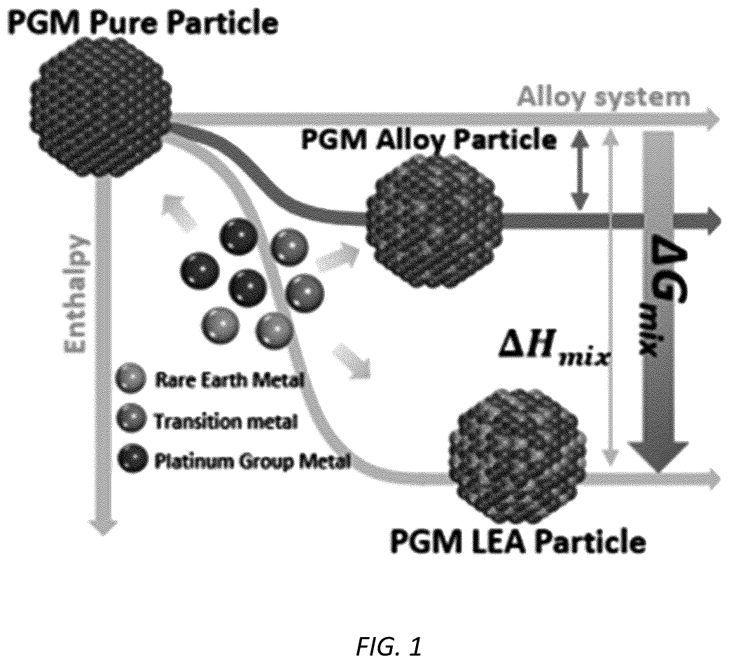

Based on the concept that the Ostwald ripening process is one of the major mechanisms responsible for catalyst degradation that leads to performance losses in platinum metal group (PGM) catalysts, the present invention seeks to reduce or eliminate the deleterious effects of this process to provide an improved platinum group metal catalyst. Studies have suggested that the critical origin of Ostwald ripening process is the platinum group metal oxidization (dissolution). The inventors, therefore, believe that if this oxidization step can be stopped or slowed down, then the stability of platinum group metal catalysts can be significantly improved. To achieve this, the present application discloses an alloy catalyst system with reduced enthalpy compared to pure metal so that the reduction potential of the catalyst system will be more positive than those of the corresponding pure metal catalyst. Therefore, the present invention in some configurations is believed to provide a low enthalpy alloy (LEA) catalyst to increase the intrinsic stability of the catalyst. The low enthalpy alloy catalyst also preferably has high catalytic activity. To accomplish this, methods of producing such catalysts are disclosed herein that incorporate certain elements which have lower formation enthalpy to increase the intrinsic stability, as schematically illustrated in FIG. 1.

Design of a low enthalpy alloy catalyst included several considerations. To achieve a low enthalpy alloy catalyst, elements which can form an alloy were selected to reduce the formation enthalpy (ΔH_{f}) of the alloy. To this end, rare earth (RE) metals (including but not limited to Sc, Ce, Y, etc.) and transition metals (including but not limited to Zr, V, Ti, etc.) can effectively lower the mixing enthalpy, ΔHₘᵢₓ. For example, alloys of Pt and some rare-earth metals (Pt—RE) have more negative formation enthalpy than most commonly studied Pt-late transition metal alloys. Based on this, the thermodynamic properties of certain solid solution binary (PGMₓA_{y}) and ternary or higher order (PGMₓA_{y}B_{(1-x-y)} alloys (B=Co or Ni) catalyst systems formed with rare earth metals (A=Sc, Ce, Y, etc.) and/or transition metals (A=Zr, V, Ti, etc.) were considered. Nonlimiting examples of such platinum group metal alloys include PtSc, PtCe, PtV, PtY, PtZr, PtTi, Pt₃Sc, Pt₃Ce, Pt₃V, Pt₃Y, Pt₃Zr, Pt₃Ti, PtScCo, PtCeCo, PtVCo, PtYCo, PtZrCo, PtTiCo, Pt₃ScCo, Pt₃CeCo, Pt₃VCo, Pt₃YCo, Pt₃ZrCo, and Pt₃TiCo.

Ternary alloys with an atomic ratio of Pt:A:B=1:1:1 were calculated to utilize the calculation of the high entropy catalysts on their thermodynamic properties. The calculated thermodynamic properties and resultant electrochemical reduction potential shift (ΔE) suggest that PtZrCo has the lowest mixing enthalpy (ΔHₘᵢₓ=−65.8 KJ/mol) followed by PtScCo (ΔHₘᵢₓ=−56.0 KJ/mol), compared to those of the pure Pt metal (ΔHₘᵢₓ=0 KJ/mol) and PtCo alloy (ΔHₘᵢₓ=−7 KJ/mol). Such reduced enthalpy also led to the reduction potential shift (ΔE) of 0.36 V and 0.30V, respectively, being greater than those of the pure Pt metal (0 V) and PtCo alloy (0.09 V). Other platinum group metal alloys, including PtVCo, PtYCo, and PtCeCo, also exhibited lower mixing enthalpies and greater reduction potential shifts compared to pure Pt metal and the PtCo alloy. It is reported that Pt catalyst nanoparticles start to oxidize at a reduction potential of around 0.85 V relative to a standard hydrogen electrode (SHE) in HClO₄ solution, which is the threshold value for Pt oxidization. In addition, it is believed that, to form a stable structure of the ternary alloy catalyst systems, each individual atom in the catalyst preferably will have similar atomic sizes, preferably minimizing atomic size differences, for example, an atomic size difference of not greater than 8.3%.

In view of this, a low enthalpy catalyst in accordance with some nonlimiting aspects of the invention may include a low enthalpy alloy core and a Pt-rich shell covering the low enthalpy alloy core. The low enthalpy alloy core may include a platinum group metal, a rare earth metal, and/or a transition metal. The low enthalpy catalyst may be in particulate form, preferably nanoparticles having, for example, average particulate sizes in the range of a few nanometers. In other nonlimiting embodiments of the invention, methods of making the low enthalpy alloy catalysts may include embedding metal ions in a carbon-nitrogen network on a carbon support, annealing the carbon support with the embedded ions, and acid leaching the annealed carbon support with the embedded ions to form a low enthalpy alloy catalyst having a low enthalpy alloy core encapsulated within a Pt-rich shell. The metal ions may all be embedded at the same time prior to the annealing, or some metal precursors could be added and embedded during the annealing.

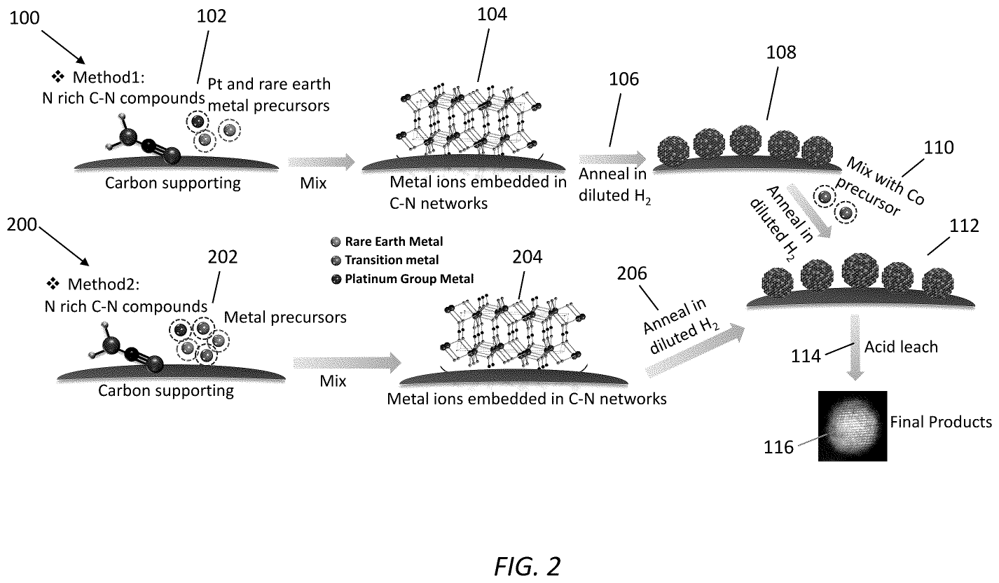

Turning now the nonlimiting examples in the drawings, FIG. 2 illustrates two methods 100 and 200 for manufacturing a low enthalpy alloy Pt catalyst in accordance with principles of the present invention. Different Pt alloy systems can be formed using the methods 100 and/or 200, such as PtA alloy catalyst systems (where A=rare earth metals, transition metals, and lanthanides, etc.). In addition, the methods 100 and/or 200 may be implemented to form ordered intermetallic PtCo binary alloy catalyst systems and PtNi catalyst systems, which are two of the most stable and active oxygen reduction reaction (ORR) catalysts.

In the first method 100, at 102 PtA alloy particles are synthesized on Pt-seeded carbon supports with existing nitrogen-rich compounds. In this step, platinum and rare earth metal precursors are mixed together with carbon supports to form metal ions embedded in C—N networks at 104. Next, at 106 the metal ions embedded in C—N networks are annealed in a diluted H₂ atmosphere to form the ordered intermetallic structure at 108. Then at 110, Co is thermally diffused into the PtA structure from 108 to form the ordered intermetallic structured ternary alloy at 112. Various annealing conditions may be employed at 110, such as using diluted hydrogen gas, to optimize the particle structure and size distributions of the resulting ordered intermetallic structured ternary alloy. Thereafter, at 114, acid leaching is employed to remove any loose attached small particles and form the core-shell structure of the low enthalpy alloy catalysts 116 having a low enthalpy alloy core with a Pt rich shell over the particles.

In the second method 200, at 202 all of the metal elements for the ultimate alloy are co-deposited at once on Pt-seeded carbon supports with existing nitrogen-rich C—N compounds. In this example, the metal elements include a rare earth metal, a transition metal, and a platinum group metal. Any one or more of the metal elements may be provided in the form of a metal precursor as appropriate to embed with the C—N networks. The carbon supports and the metal elements are then mixed together to form metal ions embedded in C—N networks at 204. Then at 206, the metal ions embedded in C—N networks are annealed in a diluted H₂ atmosphere to form the ordered intermetallic structured Pt alloy catalysts at 112. Various annealing conditions may be employed at 206 to optimize the particle structure and size distributions of the resulting ordered intermetallic structured ternary alloy. Thereafter, at 114, acid leaching is employed to remove any loose attached small particles and form the core-shell structure of the low enthalpy alloy catalysts 116 having a low enthalpy alloy core with a Pt rich shell over the particles.

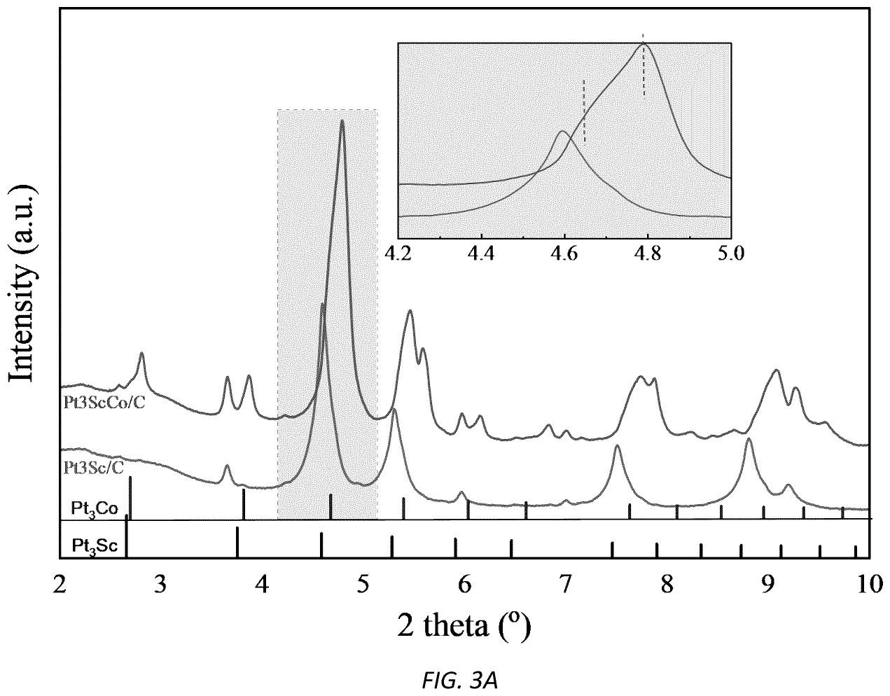

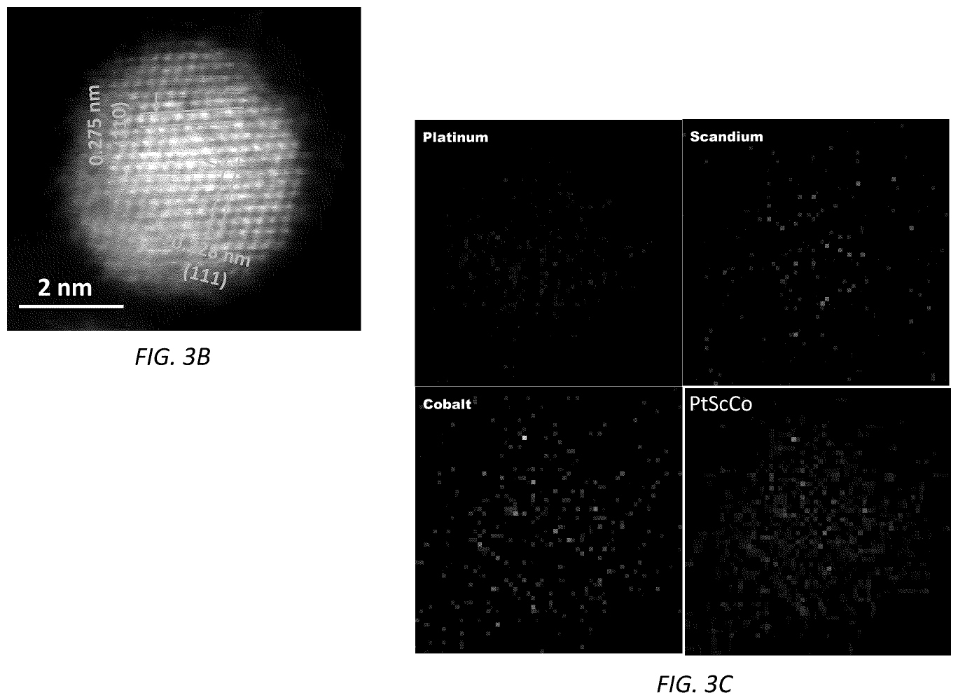

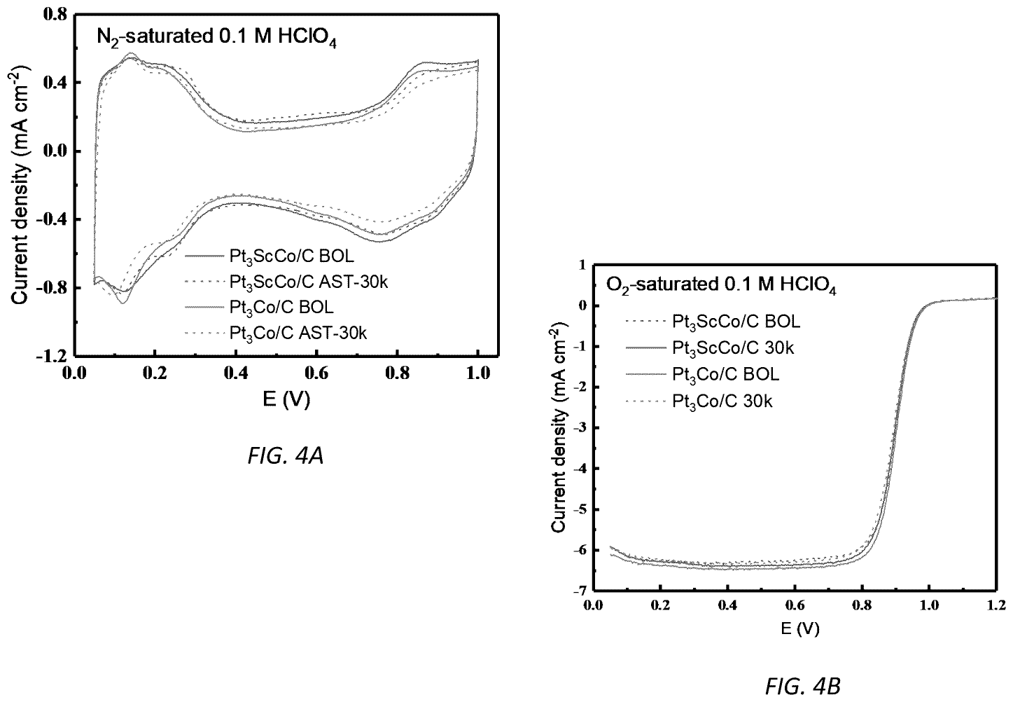

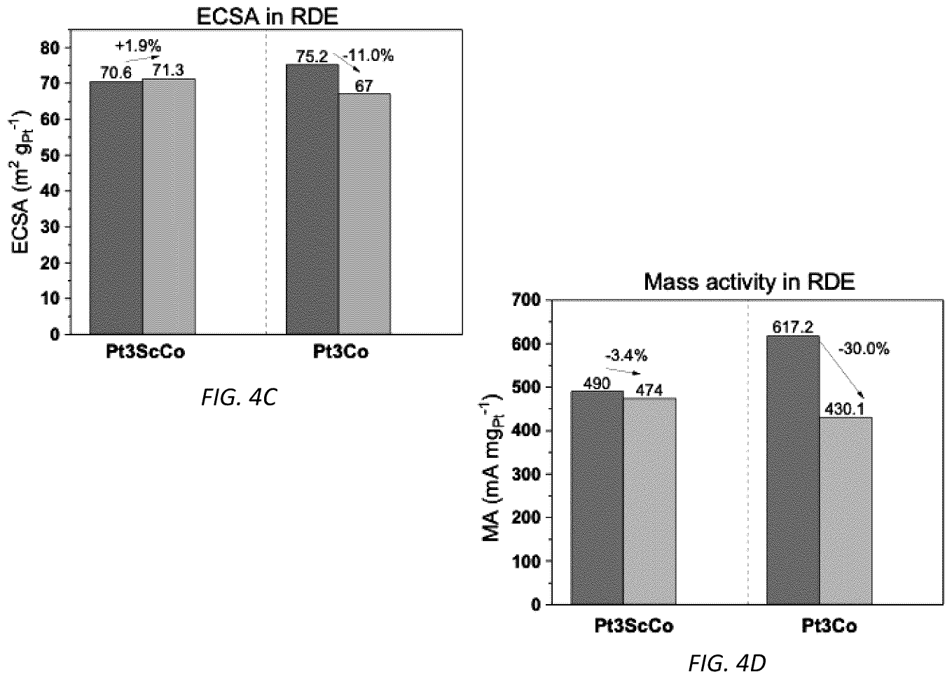

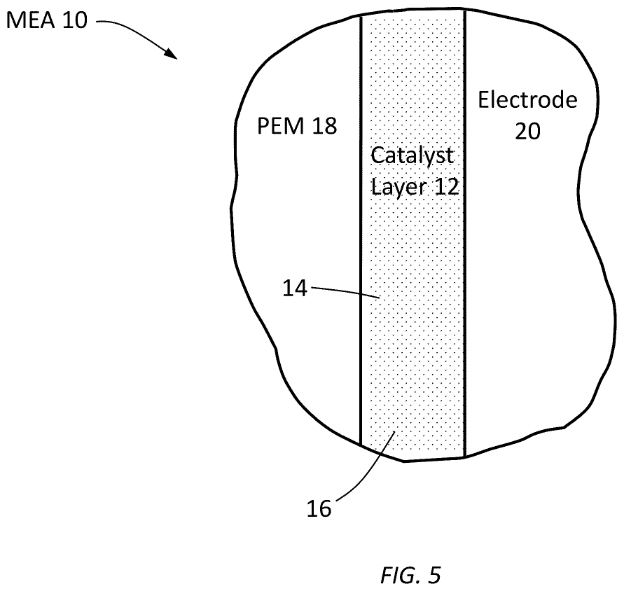

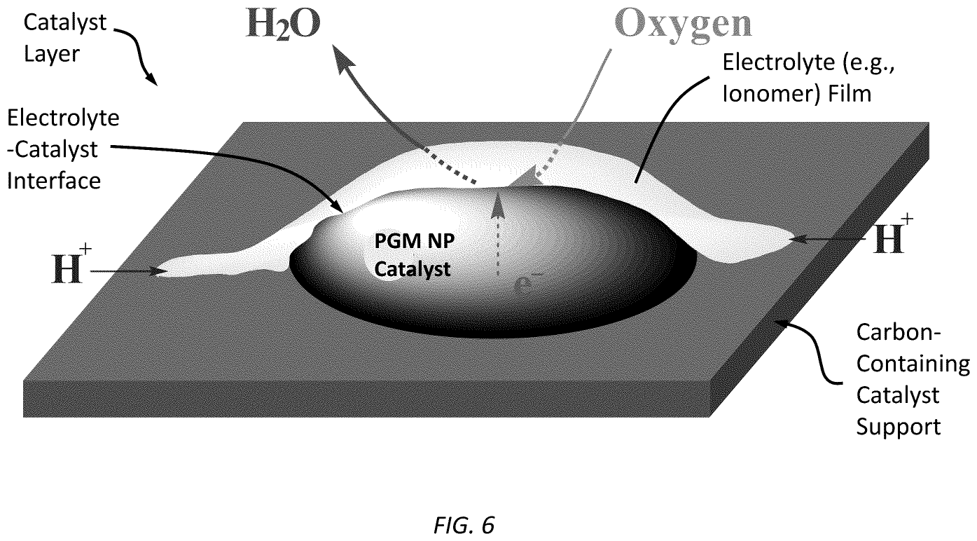

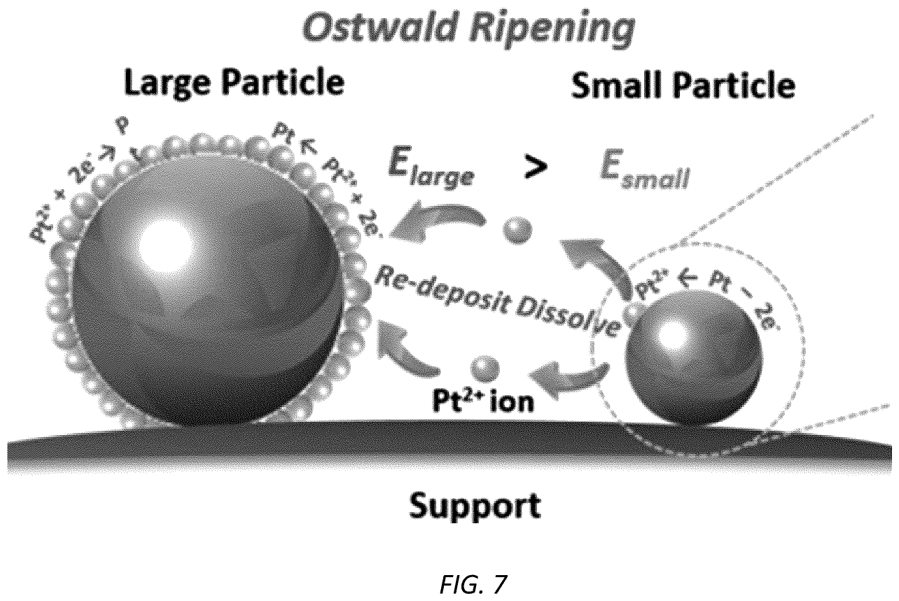

Some example low enthalpy alloy catalysts 116 that have been produced using the methods 100 and/or 200 include Pt₃Sc—Co, Pt₃V—Co, and Pt₅Ce—Co. However, other low enthalpy alloy catalysts 116 in accordance with some aspects of the present invention may include PtCoA alloys with a 1:1:1 ratio. Other low enthalpy alloy catalysts 116 in accordance with some aspects of the invention may include catalysts with optimized ratios obtained using thermodynamic calculations to optimize any of various thermodynamic characteristics, including, for example, minimizing enthalpy, maximizing entropy, and/or increased reduction potential. The current ratio in these Pt₃Sc—Co, Pt₃V—Co and Pt₅Ce—Co is estimated based on the initial results. In one particular embodiment, the Pt₃Sc—Co/C catalyst illustrates some nonlimiting aspects of the low enthalpy alloy catalysts 116. To form the Pt₃Sc—Co/C catalyst, the Pt₃Sc is first synthesized. Next, the Co is thermally diffused into Pt₃Sc particles to form Pt₃Sc—Co alloy nanoparticles. The Pt₃Sc—Co alloy nanoparticles have higher activity and stability, as shown by ex situ synchrotron XRD in FIG. 3A. The shift of the peak positions of Pt₃Sc—Co/C to higher angles compared to those of Pt₃Sc/C suggests the successful doping of Co and resultant compressive strain in Pt₃Sc/C nanoparticles. In FIG. 3B, a high-angle annular dark-field STEM (HAADF-STEM) image shows calculated lattice spacing of 0.228 and 0.275 nm that corresponds to the (111) and (110) facets, respectively, and is consistent with the XRD measurement of 0.227 and 0.277 nm. The XRD (FIG. 3A) and STEM (FIG. 3B) show the Pt₃Sc—Co nanoparticles with average particle size of 4-5 nm e, which is further illustrated from EDS elemental mapping of an individual Pt₃Sc—Co nanoparticle as shown in FIG. 3C. The core of Pt₃Sc—Co nanoparticle is formed of Pt, Sc, and Co elements and the shell is Pt-rich.

Compared with high entropy alloy (HEA) catalysts, the low enthalpy (LEA) catalysts do not rely on the numbers of the elements in the catalyst, but rather, are influence by the specific elements which have lower formation enthalpy with the platinum group metal, the element thermodynamic property dependence. The selection of the elements is thermodynamically guided, which is a rational approach and therefore can be more effective. Finally, the synthesis of low enthalpy alloy catalyst is easier than that of the high entropy alloy catalyst because a much smaller number of elements are involved. Unlike conventional high entropy alloy catalysts, in which the entropy has much less effect on the catalyst stability and requires a large number of elements to form an alloy to reduce the total Gibbs free energy of the formation of the catalyst alloy, the proposed low enthalpy alloy concept is based on the fact that the enthalpy plays a much bigger role on the catalyst stability than the entropy does.

The utilization of the low enthalpy alloy catalyst disclosed herein may fundamentally change the stability of platinum group metal catalysts, which can result in substantially longer durability of, for example, polymer electrolyte membrane fuel cells (PEMFCs) without reducing the performance of the polymer electrolyte membrane fuel cells and electrolyzers. The low enthalpy alloy catalysts make the use of polymer electrolyte membrane fuel cells for heavy duty vehicles such as trucks, ships, and locomotives economically feasible due to the increased life span/reduced cost and may reduce the carbon emission from the transportation sectors, which will have a broad impact on electrifying transportation. This in turn could lead to reductions in the use of fossil fuels and corresponding CO₂ emission. The low enthalpy alloy catalysts disclosed herein may promote the development and adoption of renewable energy, significantly reducing the cost of many industrial processes (e.g., fuel cell electric vehicles, petroleum refining, ammonia production, fine chemical, etc.), reducing carbon emission, and making the world more inhabitable.

As previously noted above, though the foregoing detailed description describes certain aspects of one or more particular embodiments of the invention, alternatives could be adopted by one skilled in the art. As such, and again as was previously noted, it should be understood that the invention is not necessarily limited to any particular embodiment described herein or illustrated in the drawings.

1. A platinum group metal (PGM) nanoparticle catalyst formed of a binary alloy PGMₓA_{y} or a ternary or higher order PGM alloy PGMₓA_{y}B_{(1-x-y)}, wherein A is a rare earth metal and/or or a transition metal and the PGM nanoparticle catalyst has a mixing enthalpy (ΔHₘᵢₓ) of less than −7.0 KJ/mol.

2. The PGM nanoparticle catalyst of claim 1, wherein the PGM nanoparticle catalyst is the binary alloy PGMₓA_{y} and A=Sc, Ce, Y, Zr, V, or Ti.

3. The PGM nanoparticle catalyst of claim 2, wherein the binary alloy PGMₓA_{y} is chosen from the group consisting of PtSc, PtCe, PtV, PtY, PtZr, PtTi, Pt₃Sc, Pt₃Ce, Pt₃V, Pt₃Y, Pt₃Zr, and Pt₃Ti.

4. The PGM nanoparticle catalyst of claim 1, wherein the PGM nanoparticle catalyst is the ternary or higher order PGM alloy PGMₓA_{y}B_{(1-x-y)} and A=Sc, Ce, Y, Zr, V, or Ti, and B=Co or Ni.

5. The PGM nanoparticle catalyst of claim 4, wherein the ternary or higher order PGM alloy PGMₓA_{y}B_{(1-x-y)} is chosen from the group consisting of PtScCo, PtCeCo, PtVCo, PtYCo, PtZrCo, PtTiCo, Pt₃ScCo, Pt₃CeCo, Pt₃VCo, Pt₃YCo, Pt₃ZrCo, and Pt₃TiCo.

6. The PGM nanoparticle catalyst of claim 1, wherein the PGM nanoparticle catalyst has a reduction potential shift (ΔE) of greater than 0.09 V.

7. The PGM nanoparticle catalyst of claim 1, wherein each individual atom in the PGM nanoparticle catalyst has a similar atomic size.

8. The PGM nanoparticle catalyst of claim 7, wherein atoms in the PGM nanoparticle catalyst have an atomic size difference of not greater than 8.3%.

9. A method of manufacturing a low enthalpy alloy catalyst, the method comprising:
co-depositing at least three metal elements, including a platinum group metal, cobalt or nickel, and a rare earth metal or a transition metal, simultaneously on a Pt-seeded carbon supports with nitrogen-rich compounds;
embedding the at least three metal elements in carbon-nitrogen networks on the Pt-seeded carbon supports;
annealing the embedded metal elements on the Pt-seeded carbon supports under diluted H₂ atmosphere to form an ordered intermetallic structured ternary Pt—A—B alloy, wherein A comprises the rare earth metal or the transition metal and B is cobalt or nickel;
acid leaching the ordered intermetallic structured ternary alloy to remove loose attached small particles and form a low enthalpy alloy catalyst comprising a low enthalpy alloy core encapsulated within a Pt-rich shell.

10. The method of claim 9, wherein A=Sc, Ce, Y, Zr, V, or Ti.

11. The method of claim 9, wherein B=Co.

12. The method of claim 9, wherein the low enthalpy alloy catalyst has a mixing enthalpy (ΔHₘᵢₓ) of less than −7.0 KJ/mol.

13. The method of claim 9, wherein the low enthalpy alloy catalyst has a reduction potential shift (ΔE) of greater than 0.09 V.

14. The method of claim 9, wherein each individual atom in the low enthalpy alloy catalyst has a similar atomic size.

15. The method of claim 14, wherein atoms in the low enthalpy alloy catalyst have an atomic size difference of not greater than 8.3%.

16. The method of claim 9, wherein the low enthalpy catalyst is a nanoparticle.

17. A method of manufacturing a low enthalpy alloy catalyst, the method comprising:
synthesizing Pt—A alloy particles on Pt-seeded carbon supports with nitrogen-rich compounds, wherein A is a rare earth metal or a transition metal;
annealing the synthesized Pt—A alloy particles on the Pt-seeded carbon supports under diluted H₂ atmosphere to form an ordered intermetallic Pt—A structure;
thermally diffusing Co or Ni into the ordered intermetallic Pt—A structure to form an ordered intermetallic structured ternary alloy; and
acid leaching the ordered intermetallic structured ternary alloy to remove loose attached small particles and form a low enthalpy alloy catalysts comprising a low enthalpy alloy core encapsulated within a Pt-rich shell.

18. A low enthalpy catalyst comprising:
a low enthalpy alloy core; and
a platinum group metal (PGM)-rich shell covering the low enthalpy alloy core.

19. The low enthalpy catalyst of claim 18, wherein the low enthalpy alloy core comprises a platinum group metal and a rare earth metal or a transition metal.

20. The low enthalpy catalyst of claim 18, wherein the low enthalpy alloy core comprises platinum, cobalt or nickel, and a rare earth metal or a transition metal.

21. The low enthalpy catalyst of claim 18, wherein the low enthalpy catalyst is a binary alloy PGMₓA_{y} and A=Sc, Ce, Y, Zr, V, or Ti.

22. The low enthalpy catalyst of claim 21, wherein the binary alloy PGMₓA_{y} is chosen from the group consisting of PtSc, PtCe, PtV, PtY, PtZr, PtTi, Pt₃Sc, Pt₃Ce, Pt₃V, Pt₃Y, Pt₃Zr, and Pt₃Ti.

23. The low enthalpy catalyst of claim 18, wherein the low enthalpy catalyst is a ternary or higher order PGM alloy PGMₓA_{y}B_{(1-x-y)} and A=Sc, Ce, Y, Zr, V, or Ti, and B=Co or Ni.

24. The low enthalpy catalyst of claim 23, wherein the ternary or higher order PGM alloy PGMₓA_{y}B_{(1-x-y)} is chosen from the group consisting of PtScCo, PtCeCo, PtVCo, PtYCo, PtZrCo, PtTiCo, Pt₃ScCo, Pt₃CeCo, Pt₃VCo, Pt₃YCo, Pt₃ZrCo, and Pt₃TiCo.

25. The low enthalpy catalyst of claim 18, wherein the low enthalpy catalyst is a nanoparticle.

26. The low enthalpy catalyst of claim 18, wherein the low enthalpy catalyst has a mixing enthalpy (ΔHₘᵢₓ) of less than −7.0 KJ/mol.

27. The low enthalpy catalyst of claim 18, wherein the low enthalpy catalyst has a reduction potential shift (ΔE) of greater than 0.09 V.

28. The low enthalpy catalyst of claim 18, wherein each individual atom in the low enthalpy catalyst has a similar atomic size.

29. The low enthalpy catalyst of claim 28, wherein atoms in the low enthalpy catalyst have an atomic size difference of not greater than 8.3%.
